(19) United States
(12) Patent Application Publication
(10) Pub. No.: US 2011/0073740 A1
(43) Pub. Date: Mar. 31, 2011

(54) Book holder

(76) Inventor: Leon Leduc, Clinton Twp., MI (US)

(21) Appl. No.: 12/586,832

(22) Filed: Sep. 29, 2009

(51) Int. Cl. B42D 9/04

(52) U.S. Cl. 248/451

(57) ABSTRACT

Holder consists of a base connected to fences at each end. Legs, one at each side of the base, are attached to the base at the movable fence end. Deploying legs positions the base in an acceptable book reading angle with the movable fence upward. Books, hard or soft cover, are held in place on the base by the inside edges of page tab assemblies which are spring loaded to the fences through elongated slots. Tabs are adjusted to hold down pages of a book by moving them perpendicularity and/or side to side over each side of an opened book's pages. Further tab adjustments needed to obtain a clear field of reading vision is obtain by rotating the tab page retainers. Page turning is accomplished without further adjustment or movement of the tab assembly.

### CROSS-REFERENCE TO RELATED APPLICATIONS

None

### FEDERALLY SPONSORED RESEARCH

Not Applicable

### SEQUENCE LISTING OR PROGRAM

Not Applicable

### BACKGROUND

1. Field

This application relates to four post book holder designs.

2. Prior Art

My patent searching consisted of looking at book holders at book stores. Further searches at WWW.freepatentonline.com reviled many four (4) post designs. There were book holders with page retainers that have to be moved in order to turn book pages. Page retainers in my design are easy to adjust. Once adjusted only slight adjustments are necessary during the reading of the held book. Page retainers do not have to be readjusted or moved to turn the read page of a held book.

### SUMMARY

Holder consist of a base with legs to adjust reading angle. A upper movable fence and a lower stationary fence are provided to hold books in place. Movable tab assemblies with page retainers are attached to these fences in slots provided. Tab assemblies are attached to the fence slots with coil springs and steel pins. This attachment allows the tab assemblies to be moved perpendicularly and/or side to side. This tab movement results is complete adjustability of the page retainers. Turning of the held book's read page is accomplished without any need to move or adjust the tab or page retainer assemblies.

### DRAWINGS

### Figures

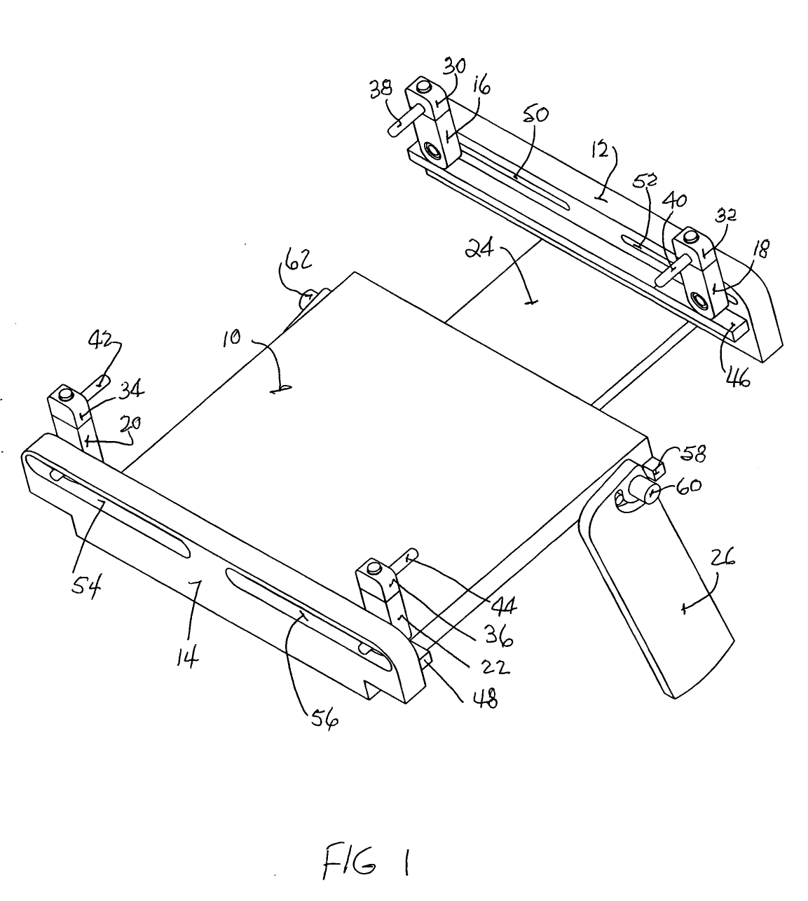

FIG. 1—isometric top view of holder showing upper movable fence in a open position.

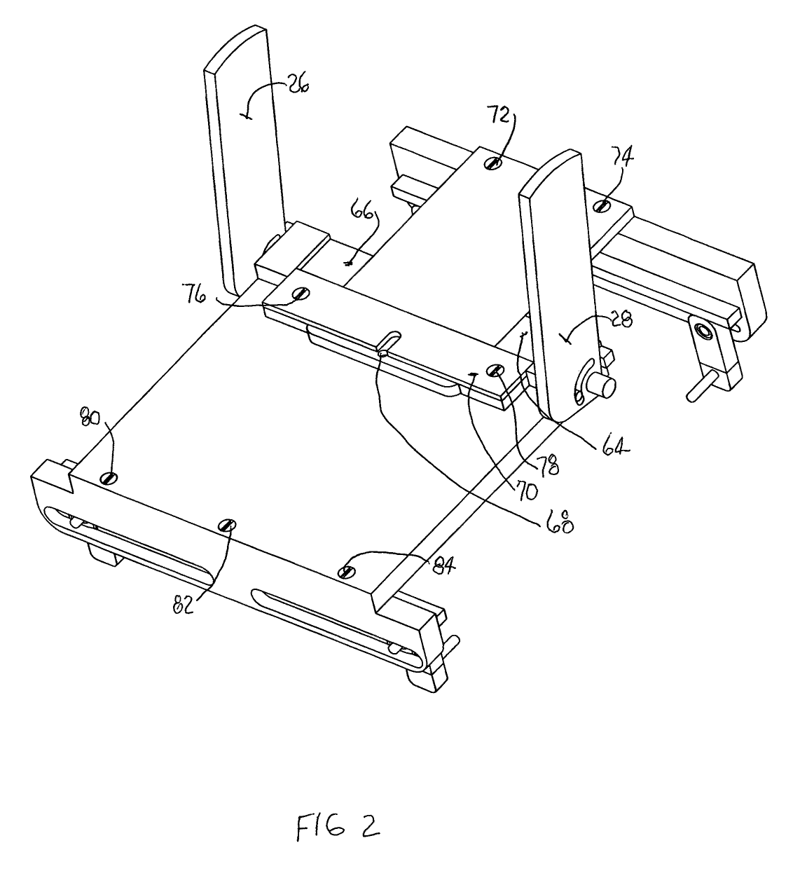

FIG. 2—isometric bottom view of holder showing upper movable fence in a open position.

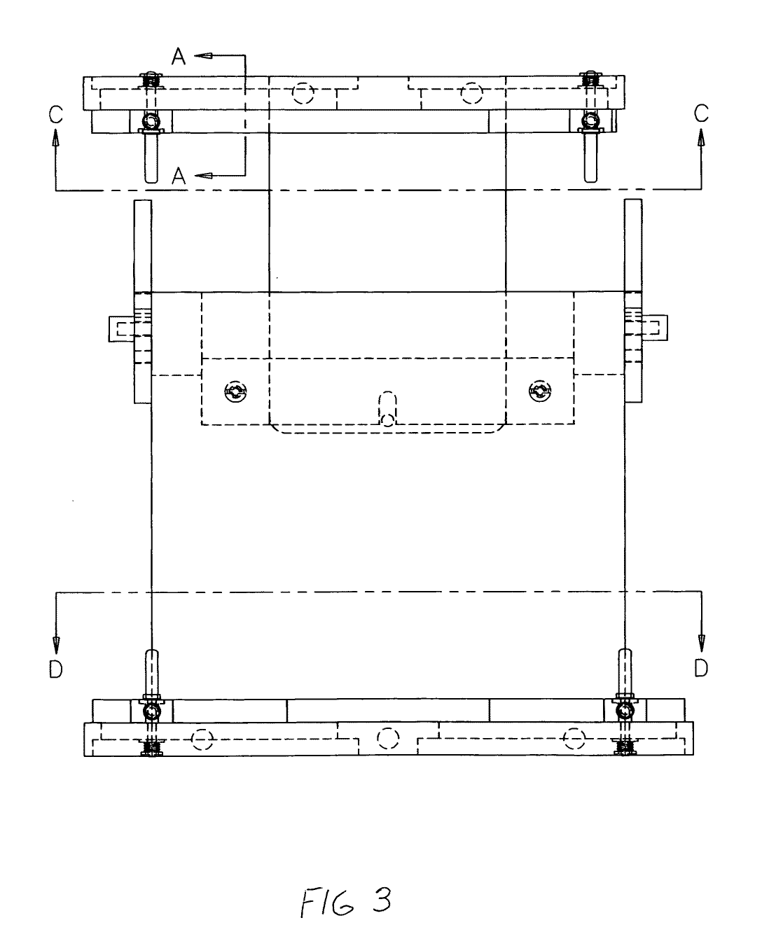

FIG. 3—view of holder showing where section areas A-A, C-C, D-D are located.

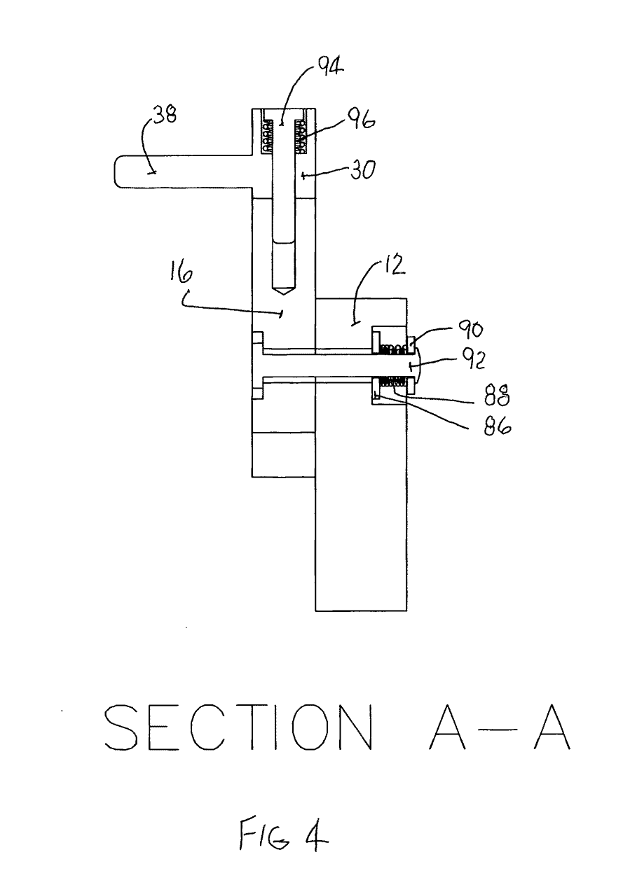

FIG. 4—section view A-A showing how the tab assemblies are constructed and connected thru the slots in the top and bottom fences.

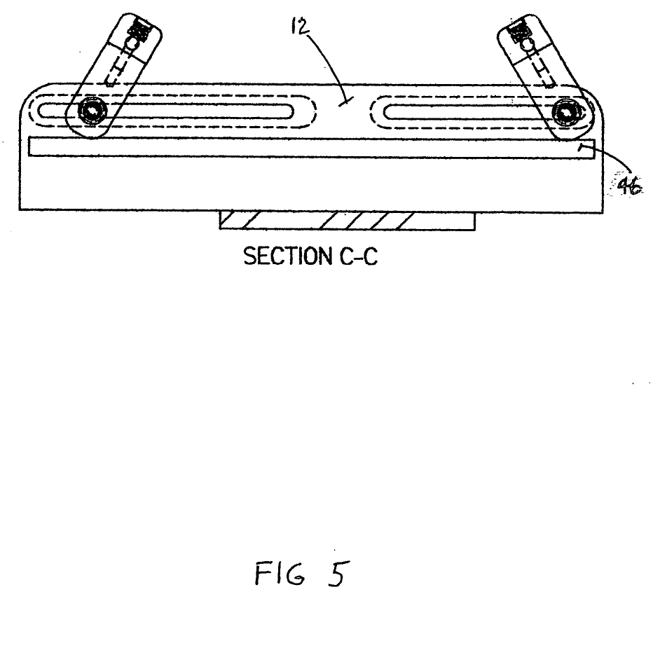

FIG. 5—C-C section of top fence/book cover retainer bar assembly.

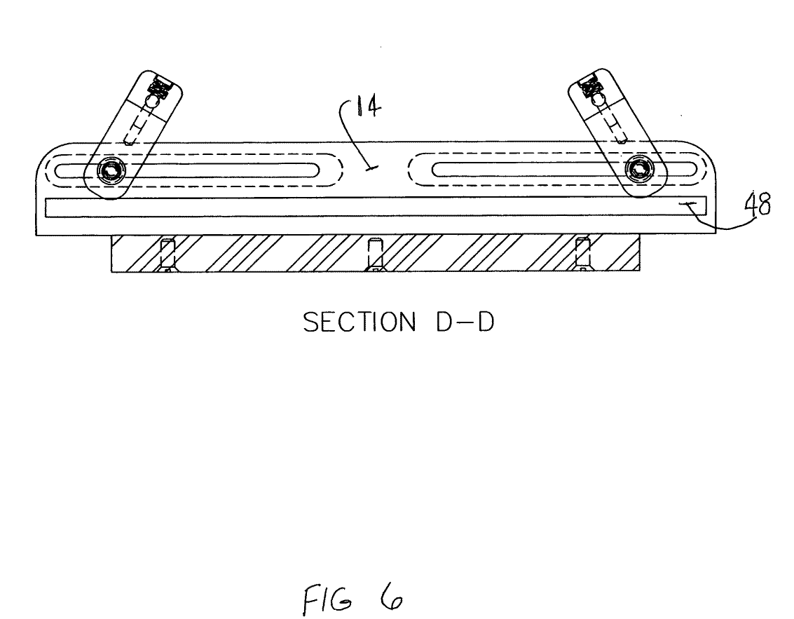

FIG. 6—D-D section of bottom fence/book cover retainer bar assembly.

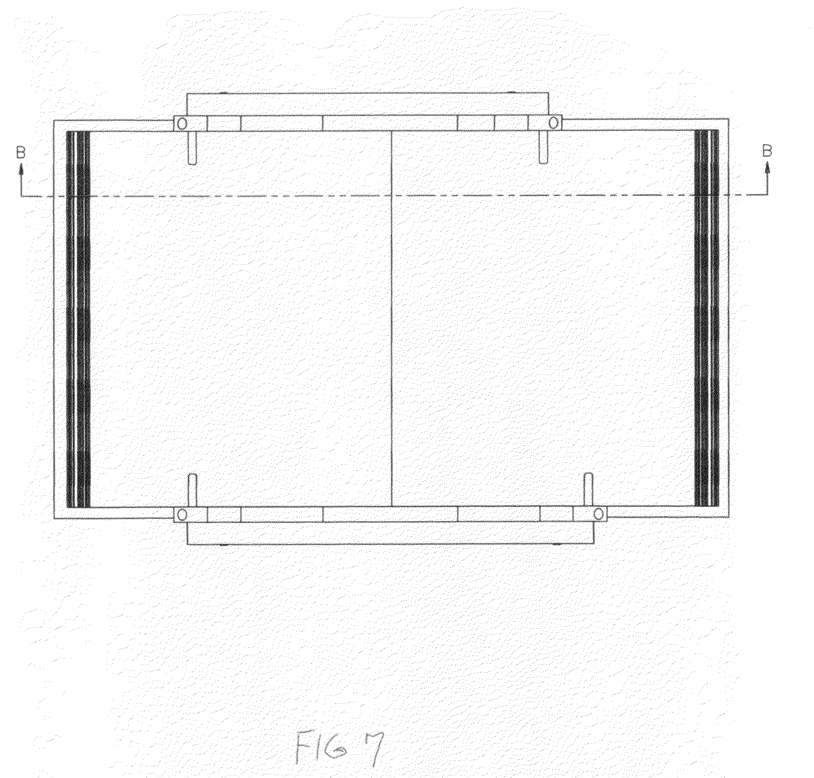

FIG. 7—Book in holder showing B-B section.

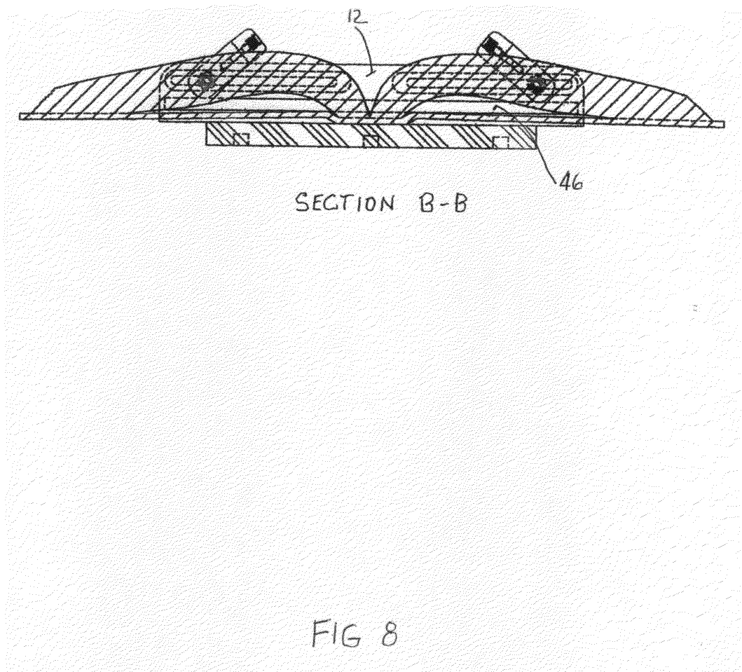

FIG. 8—B-B section of book cover/retainer bar view.

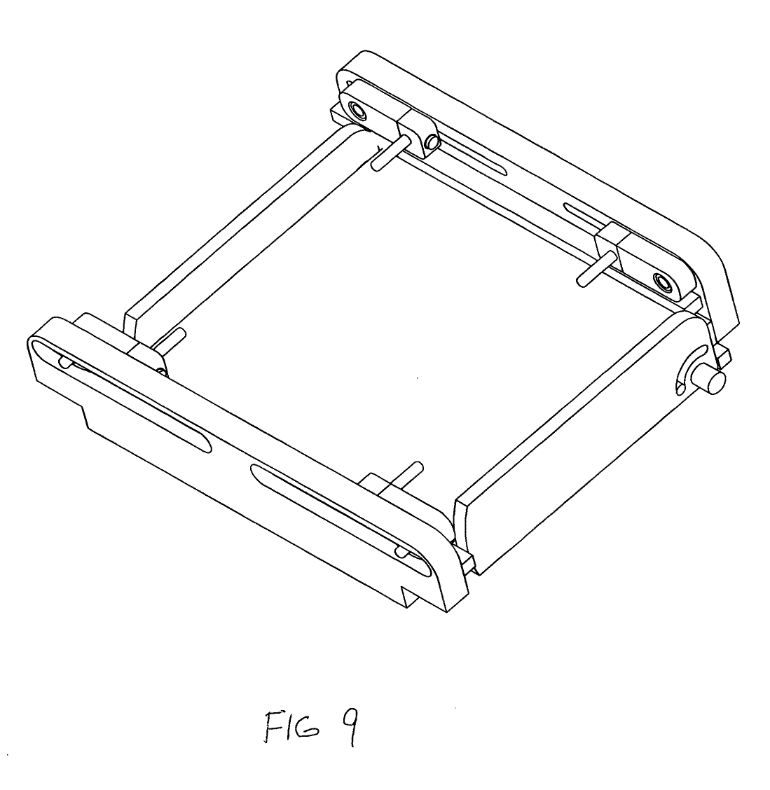

FIG. 9—isometric view of holder folded into storage mode.

### DRAWINGS

### Reference Numerals

| 10 | base | 12 | top fence | 14 | bottom fence |
|---|---|---|---|---|---|
| 16 | tab assembly | 18 | tab assembly | 20 | tab assembly |
| 22 | tab assembly | 24 | slide | 26 | leg |
| 28 | leg | 30 | page retainer assy | 32 | page retainer assy |
| 34 | page retainer assy | 36 | page retainer assy | 38 | page retainer |
| 40 | page retainer | 42 | page retainer | 44 | page retainer |
| 46 | book cover | 48 | book cover | 50 | fence slot |
| | retainer bar | | retainer bar | | |
| 52 | fence slot | 54 | fence slot | 56 | fence slot |
| 58 | leg stop | 60 | leg lock | 62 | leg lock |
| 64 | slide guide | 66 | slide guide | 68 | slide stop |
| 70 | slide retainer | 72, 74, 76, 78, 80, 82, 84 screws | | | |
| 86 | nylon washer | 88 | coil spring | 90 | steel washer |
| 92 | assembly pin | 94 | page retainer assy | 96 | retainer spring |
| | | | pin | | |

### Detailed Description of FIGS. 1 to 9

FIGS. 1 and 2 show the top and bottom of the holder with the top fence 12 moved up. FIG. 2 shows the slide 24 which allows the top fence to move. The movement of top fence allows books of various sizes to be installed in the holder. FIG. 1 further shows the four tab assemblies 16,18,20,22 fastened to the upper and lower fences.

The tabs are fastened to the fences as shown in FIG. 4. Sec A-A. Tabs are spring loaded to the slots FIG. 1, 50,52,54,56 on each fence. Tabs can move perpendiculy, side to side, relative to the fences in the slots provided. Because of this movement the page retainers 38,40,42,44 can be adjusted to hold book pages down.

FIGS. 5,6 show the top fence 12 Sec C-C and bottom fence 14 Sec D-D. These two sections show the cover retainer bars 46, & 48. Book hard covers slip under these bar retainers when hard cover books are retained by the holder. FIG. 8, Sec B-B shows a hard cover of a book under the retainer bar 46.

FIG. 9 shows the holder in storage mode. Legs are folded up. Page retainer tab assemblies are folded down.

### Operation FIG. 1,2,4,5,6,7,8,9

Beginning with holder in storage mode FIG. 9. Place holder on a horizontal surface. Adjust legs 26,28 and lock 60,62. Open base area 10 by moving upper fence 12 up obtaining space needed to accommodate book. Stand up the four (4) page tab assemblies 16,18,20,22. To install a hard cover book first rotate the four (4) To install a hard cover book first rotate the four (4) page retainer assemblies 30,32,34,36 outward from the holder base. This will allow the book's pages, after installation, to be turned to the readers chosen start page without interference from the page retainers 38,40,42,44. Open book so that its back binding can be laid flat on the holder base 10. Insert bottom book binding under lower fence retainer bar 48. Holding open book flat to the base 10, close upper fence 12 to top of book's pages. When the top fence 12 is moved down the book's hard cover will slip under the top fence retainer bar 46. The book, with its cover held down by the retainer bars 46,48, is now moved to extend beyond the top fences 12 right edge. This overlapping of the top fence right edge is required in order to facilitate page turning.

With the open book positioned in the holder the page retainer assemblies 30,32,34,36 can be rotated back so that the retainers 38,40,42,44 are positioned over the book's pages.

Adjustments of the page tab assemblies 16,18,20,22 is done by moving them in the fence slots 50,52,54,56. This positions the page retainers 38,40,42,44. Tab assemblies 16,18,20,22 are spring loaded and single pinned to the fences thru the fence grooves 50,52,54,56 (FIG. 4). This allows them to move perpendicularly and/or side to side. This movement allows a wide range of adjustment of the page retainers 38,40,42,44.

These adjustments will result with the pages of the book being held down in an acceptable reading position. Proper retainer 38,40,42,44 adjustments will result in a unobstructed view of the book's words. Page retainers 38,40,42,44 can be rotated, if required, to clear book words if the book top and bottom margins are narrow. In this position they will still retain the book pages. Room is left between the adjusted book pages and the holder base. This is to facilitate page turning.

Page turning without any further adjustments to the page tab assemblies 16,18,20,22 is accomplished by placing the tip of the right hand index finger at the top edge of the book's right page and lifting the page. The lifted page will slip out from under the top right page retainer 40. When the page is moved to the left side of the book holder the page will slip out from under the bottom right retainer 44. Since space was left between the open book retained pages and the holder base, the turned page can easily be tucked under the left top and bottom page retainers 38,42. The turning of pages in this holder is much like turning a hand held book page. Turning of pages is accomplished using one hand only. At no time during the turning of pages is any further adjustments required of the page tab assemblies 16,18,20,22. Some minor adjustments of the tab assemblies 16,18,20,22 may be necessary as the book is being read. This is due to the book's thickness and page springiness changing as the pages of the book are moved side to side.

The installment and holding operation of books without hard covers is accomplished the same way as explained above. Of course there are no hard covers to slip under the fences 12,14 cover retainer bars 46,48. The lack of hard covers will not effect the holding of these types of books since all books in this holder are held in place by the page tab assemblies 16,18,20,22 and the leading edge of the hard cover retainer bars 46,48.

I claim:

1- Both hard or soft cover books of various sizes and thicknesses can be held and easily read with a clear field of vision in this book holder design.

2- (canceled)

3- (canceled)

4- Pages can be turned with one hand without any adjustments to the page tab assemblies which contain the actual page retainers. There are no clamps or livers to move or operate.

5- This book holder design adds to the art of book holders.
